(19) United States
(12) Patent Application Publication
(10) Pub. No.: US 2018/0121536 A1
(43) Pub. Date: May 3, 2018

(54) Verification Assistance System and Method

(71) Applicant: Hitachi, Ltd, Tokyo (JP)

(72) Inventors: Marina FUJITA, Tokyo (JP); Toshiko AIZONO, Tokyo (JP); Koji ARA, Tokyo (JP)

(21) Appl. No.: 15/561,431

(22) PCT Filed: Nov. 27, 2015
(86) PCT No.: PCT/JP2015/083363

§ 371 Date: Sep. 25, 2017

(51) Int. Cl. G06F 17/30

(52) U.S. Cl. CPC G06F 17/30604; G06F 17/30554; G06F 17/30528

(57) ABSTRACT

A verification assistance system comprises: a first computation unit which, based on the name of a concept defined by an arbitrary word, searches a database to extract a plurality of behavior history data linked with the concept; a second computation unit which calculates the number of data items that are common among the plurality of extracted behavior history data to calculate the ratio by which a certain concept is linked with another concept; and a third computation unit which, based on the ratio, determines whether the certain concept and the other concept have an abstract relationship of any of upper/lower, identical, and no-relation.

### TECHNICAL FIELD

The present invention relates to a system and a method for assisting verification of a plan or the effect of an operation.

### BACKGROUND ART

To ensure a smooth operation, it is important to identify or review the factors of the operation, in tandem with the execution of the operation, so as to plan the next operation efficiently. In an operation where the plan-do-check-act (PDCA) cycle is automated, automatic improvement of the operation is achieved based on a history of execution of the operation. For example, in a service where a consumer is recommended a specific product (hereafter referred to as “product recommend service”), when the variable items are limited to “product” and “consumer”, a data analysis scheme such as collaborative filtering (Non Patent Literature 1) is applied to automate the PDCA cycle in some cases.

However, if the relationship between the operation and a factor model affecting the operation is not clearly defined, PDCA cycle automation may be difficult, and may require analysis or decision making by a person in charge of operations during operational planning or its review phase. For example, in the above-mentioned product recommend service, if a service content were to be analyzed without limiting the variable items, there would be numerous factors with potential to affect consumer behavior, and automatic execution of the PDCA cycle would become difficult.

In the meantime, in service companies in the retailing industry in particular, it is desirable to update the consumer behavior model by creating new factors in the course of the PDCA cycle, so that a service adapted to the diverse and fast-changing needs of the consumer can be provided. Against these backgrounds, it is currently considered important to manually design services with a high degree of freedom depended on the knowledge, experience and the like of the person in charge of operations.

### CITATION LIST

### Patent Literature

Patent Literature 1: JP 2009-301432 A

### Non Patent Literature

Non Patent Literature 1: “Amazon.com Recommendations: Item-to-Item Collaborative Filtering”, Greg Linden, Brent Smith, Jeremy York, Journal IEEE Internet Computing 7, 1, pp. 76-80, 2003.

### SUMMARY OF INVENTION

### Technical Problem

When the PDCA cycle is manually run by the person in charge of operations, the person, who qualitatively understands the relationship between the factors of the operation and their actual influence, derives an improvement proposal for the service based on his or her own understanding. This technique has the advantage of enabling an analysis of the relationship between an arbitrary factor and its influence and thus providing a high degree of freedom. On the other hand, it is difficult with the technique to comprehensively identify a plurality of causal relationships estimated from different viewpoints. This is because the causal relationship according to the understanding of the person in charge of operations is one-sided, possibly resulting in the derivation of a plurality of different causal relationship models depending on a difference in the counting unit or a difference in data items to be focused. For example, when the psychological purchasing factor of the consumer is focused, a tendency indicating that “consumers who have health-conscious values are likely to purchase health foods” may be derived; when the demographic unit is focused, a tendency indicating that “housewives are likely to purchase low-priced products” may be derived.

Patent Literature 1 discloses a system that presents associated words for assisting the user's imagination, by utilizing a technology to estimate the upper/lower or older/younger brother relationships, or no-relation. The technology is estimating a textual semantic relationship. However, concepts generated in order to interpret the implementation results of an operation may indicate different contents while being similar in meaning, and the system disclosed in Patent Literature 1 does not make it possible to estimate the similarity between concepts. That is, there is a need for a technology which is not just for simple semantic analysis of words but that makes it possible to identify the degree of overlap in the substance that each concept points to (for example, in the case of concepts relating to consumers, an actual consumer group; in the case of concepts relating to products, an actual product group).

The inventor, in light of the problems discussed above, proposes a technology for integrating causal relationship models between a plurality of concepts that are defined with arbitrary word.

### Solution to Problem

In order to solve the problems, the present invention adopts the configurations set forth in the claims, for example. The present description includes a plurality of means for solving the problems, of which one example is “a verification assistance system including: a first computation unit which searches a database by a name of a concept defined by an arbitrary word, and which extracts a plurality of behavior history data linked with the concept; a second computation unit which, by calculating the number of data items that are common among the plurality of extracted behavior history data, a ratio by which a certain concept is linked with another concept; and a third computation unit which, based on the ratio, determines whether the certain concept and the other concept have an abstract relationship of any of upper/lower, identical, and no-relation.

### Advantageous Effects of Invention

According to the present invention, an abstract relationship between a plurality of concepts defined in arbitrary word can be determined, and it becomes possible to integrate a plurality of causal relationships through the abstract relationship. Other problems, features, and effects will become apparent from the following description of embodiments.

### BRIEF DESCRIPTION OF DRAWINGS

FIG. 1 illustrates an overall configuration of an operation planning and its effect verification assistance system according to Example 1.

FIG. 2 illustrates an example of a concept definition screen.

FIG. 3 illustrates an example of concept grant result data.

FIG. 4 illustrates an example of a causal hypothesis input screen.

FIG. 5 is a functional component flowchart illustrating a method for associating concept and data and for updating a concept-to-concept causal relationship.

FIG. 6 illustrates a pictorial representation of a concept-to-concept abstract relationship.

FIG. 7 is a flowchart illustrating an abstract relationship estimation process procedure.

FIG. 8 illustrates an example of an operation parameter design screen.

FIG. 9 illustrates an example of an analysis screen.

FIG. 10 is a flowchart illustrating a work procedure example for designing an operation parameter.

FIG. 11 illustrates an example of an operation ID×model ID table.

FIG. 12 illustrates an example of an operation evaluation screen.

### DESCRIPTION OF EMBODIMENTS

In the following, based on the drawings, an embodiment of the present invention will be described. The modes of implementation of the present invention, however, is not limited to the following Example, and various modifications may be made within the technical scope of the invention. In the following, a system for assisting the planning of an operation or the analysis of improvements by a person in charge of operations will be described. The system, by modeling actual operation history data on the basis of “qualitative” knowledge regarding an influence on an operation implementation result required for evaluating and planning operations, makes it possible to perform a “quantitative” prediction of an operation effect, or to evaluate an influence model based on the knowledge.

### (1) Example 1

In the present Example, an operation planning and its effect verification assistance system (hereafter referred to as “assistance system” or “system”) will be described which includes: a function for generating, based on qualitative knowledge input from a person in charge of operations, a causal model for operation effect prediction from actual operation history data (such as actual purchase history); a function for receiving the addition of a factor expressed by an arbitrary concept name with respect to the generated causal model; and a function for evaluating, based on actual behavior history data, the relationship between various factors assumed by the person in charge of operations.

In the following description, a case in which the assistance system is used for operation planning or verification of a consumer-oriented service in retail operations will be described. In consumer-oriented services, it is important to identify a causal relationship regarding the consumption behaviors of consumers, and provide services that promote store visits or product purchases. Accordingly, the assistance system according to the present Example includes the function for generating a data model of the consumption behaviors of consumers based on the qualitative knowledge of the person in charge of operations. The consumption behaviors may include a purchase behavior, a store visit behavior, and a coupon distribution application viewing behavior. The assistance system estimates the quantitative effect that a factor defined by the input from the person in charge of operations may have on each behavior, on the basis of: purchase history data in the case of “purchase behavior”; shop visit history data in the case of “store visit behavior”; or application viewing history data in the case of “coupon distribution application viewing behavior”. That is, the assistance system expresses the causal relationship of a qualitative concept level based on the input knowledge of the person in charge of operations, as a quantitative model on data.

### (1-1) Overall Configuration of Assistance System

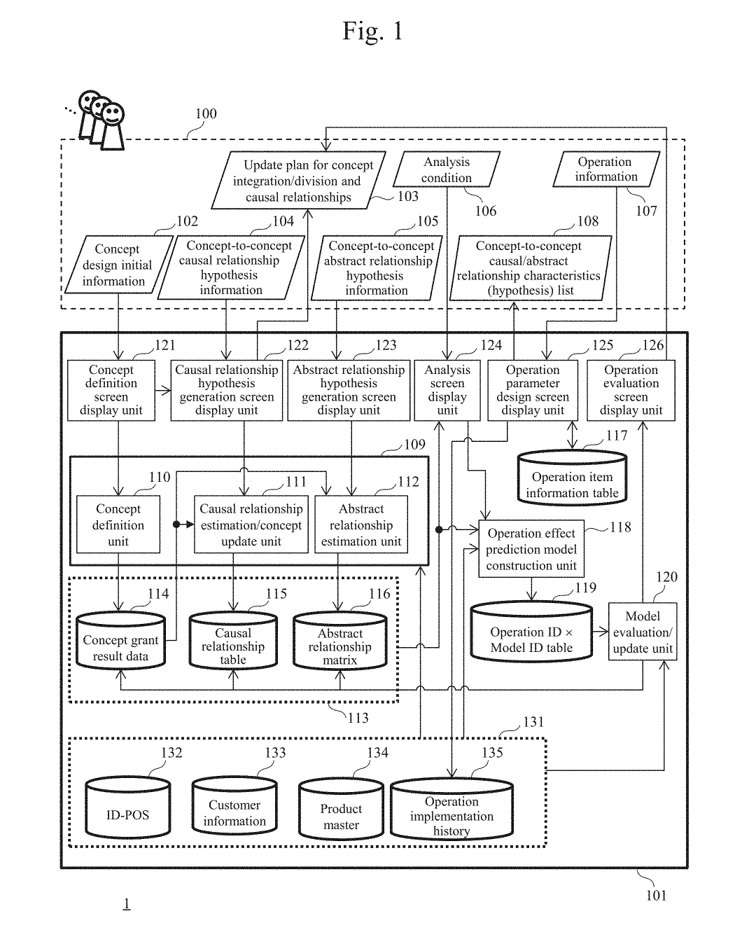

FIG. 1 illustrates the configuration of an assistance system 1 according to Example 1. The assistance system 1 includes a terminal 100 operated by the person in charge of operations, and a central server 101. The terminal 100 and the central server 101 are comprised of computers (including a CPU, a RAM, a ROM, and a hard disk device) as a basic configuration. In FIG. 1, information that is input and output with respect to the central server 101 is represented in association with the terminal 100. For the input and output of information, manipulation screens are used. The manipulation screens include: a concept definition screen; a causal relationship hypothesis generation screen; an abstract relationship hypothesis generation screen; an analysis screen; an operation parameter design screen; and an operation evaluation screen. The assistance system 1, via the manipulation screens, assists an operation of the person in charge of operations (for example, customer need identification, operation parameter review; operation planning; or implementation result evaluation for improvement).

The central server 101 implements the various functions and screens illustrated in FIG. 1 via execution of a program by the computer. The central server 101 has a screen display unit with a display screen on which the various manipulation screens are displayed. In FIG. 1, the manipulation screens are represented as independent display units. Of the display units illustrated in FIG. 1, a concept definition screen display unit 121, a causal relationship hypothesis generation screen display unit 122, and an abstract relationship hypothesis generation screen display unit 123 are used for the input of information used for model generation (for example, concept design initial information 102, concept-to-concept causal relationship hypothesis information 104, and concept-to-concept abstract relationship hypothesis information 105), and for the output of an update proposal 103 for concept integration/division and causal relationships.

A model generator 109 includes a concept definition unit 110, a causal relationship estimation and concept update unit 111, and an abstract relationship estimation unit 112, and generates a data model of a causal relationship and an abstract relationship on the basis of the qualitative knowledge (knowledge regarding consumer and their consumption behavior) of the person in charge of operations. The model generator 109 generates an output comprising causal/abstract relationship data model information 113 (concept grant result data 114, a causal relationship table 115, and an abstract relationship matrix 116).

The central server 101 also includes screen display units (an analysis screen display unit 124, an operation parameter design screen display unit 125, and an operation evaluation screen display unit 126) used for assisting consumer behavior identification and operation result review. An operation effect prediction model construction unit 118, on the basis of the inputs through the display units, constructs a prediction model of the effect that various factors may have on the consumer during operation implementation, and outputs an operation ID×model ID table 119.

A model evaluation/update unit 120, by referring to the operation ID×model ID table 119, creates and displays a screen for assisting Check & Action after operation implementation on the operation evaluation screen display unit 126. The model evaluation/update unit 120 compares a previously constructed consumer behavior prediction model at the time of operation implementation and actual behavior history data to evaluate a model. The model evaluation/update unit 120 also updates the model so as to better map the actual data, and updates the causal/abstract relationship data model information 113.

In an operation data storage 131 (ID-POS 132, customer information 133, a product master 134, an operation implementation history 135), the operation history data used by the model generator 109, the operation effect prediction model construction unit 118, and the model evaluation/update unit 120 are stored. The central server 101 also accepts the input of a new operation parameter using an operation item information table 117. An analysis condition 106, operation information 107, and a concept-to-concept causal/abstract relationship characteristics (hypothesis) list 108 will be described later.

### (1-2) Manipulation Screens

### (1-2-1) Concept Definition Screen

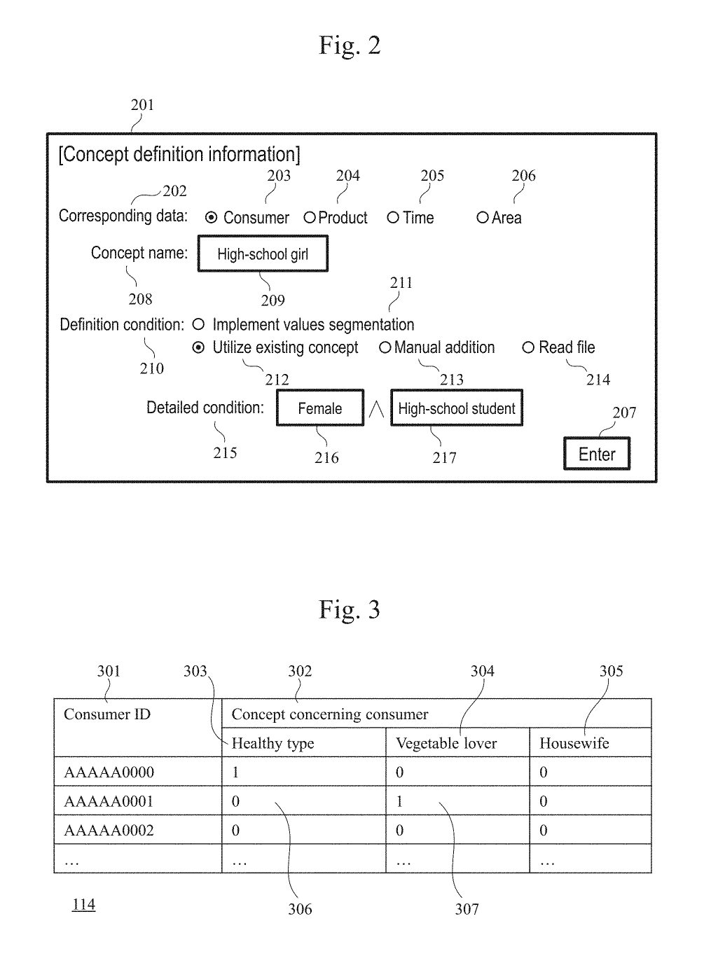

FIG. 2 illustrates an example of a concept definition screen 201 used for accepting concept design initial information 102. The concept definition screen 201 is a screen for accepting input information with respect to the concept definition unit 110. In order to express the qualitative knowledge contemplated by the person in charge of operations as a model on data, it is necessary to clarify what of the actual operation history data the concept contemplated by the person in charge of operations reflects. In the case of the present Example, a definition is based on an association between a concept with an arbitrary name and data on the actual operation history data. The actual association is executed by the concept definition unit 110.

The concept definition screen 201 includes the input items of corresponding data 202 meaning the type of concept, a concept name 208, and a definition condition 210 designating an initial association method for concept and data. The concepts that are factors of a consumer behavior model include a concept concerning the consumer and a concept concerning the product, which are respectively expressed as a set of actual consumers and a set of products.

The concept definition unit 110 determines the correspondence between actual data and each concept that can be expressed in an entry field 209 of the concept name 208. For example, the concept “high-school girl” can be expressed by a set of consumers. Accordingly, the concept definition unit 110 extracts from a consumer ID list the actual consumer ID of high-school girl, and outputs its correspondence as concept grant result data 114. An example of the concept grant result data 114 will be described later.

In the present Example, as the selection items corresponding to the corresponding data 202, a consumer 203, a product 204, a time 205, and an area 206 are prepared. The person in charge of operations, using the selection items, selects data set as belonging to the concept. The selection items, however, may not be limited to the above. For example, concepts concerning external factors and the like, such as the weather, may be contemplated. Accordingly, external factors and the like may be included in the alternatives of the corresponding data 202.

In the present Example, the concept definition screen 201 is displaying an example for defining a concept concerning the consumer, with “high-school girl” input in the entry field 209 of the concept name 208 as a specific example. The definition condition 210 is used for selecting the scheme for extracting the correspondence with actual data. In the case of FIG. 2, as selection items, “implement values segmentation” 211, “utilize existing concept” 212, “manual addition” 213, and “read file” 214 are prepared. However, the methods for linking the concept with actual data are not limited to the above. In the screen example, “utilize existing concept” 212 is being selected, where, by extracting the consumer that is included in both of the existing concepts of “female” 216 and “high-school student” 217 in a detailed condition 215, the association of concept and data is indicated.

If the “implement values segmentation” 211 is selected in the definition condition 210, the concept is linked with a consumer group (values segment) that is expected to share the same values. The values segment may be generated by a method for estimating a consumer group on the basis of a questionnaire, and also a method that uses a purchase history. In the method using a purchase history, a consumer group that purchases, with a high frequency, a product that has a high probability of being purchased by a consumer group sharing the same values is considered the consumer group of the segment concerning the values being focused.

If the “manual addition” 213 is selected, it is conventional to implement consumer segmentation in accordance with the number of flags of the values segment granted to the product. It should be noted, however, that, as will be described later, highly accurate segmentation may be implemented by the updating of the consumer group or the corresponding product group, or by the estimation of the causal relationship between the consumer and product. As the person in charge of operations determines the input content by operating an enter button 207 illustrated in the drawing, the concept of the concept name 208 that has been input is associated with the actual data on the basis of the concept definition information that has been input.

FIG. 3 illustrates an example of the concept grant result data 114. In the concept grant result data 114, the correspondence between a concept concerning the consumer and data concerning an actual consumer is recorded. The concept grant result data 114 are composed of a column 301 concerning the consumer ID, and a column 302 of concept concerning the consumer. The concept concerning the consumer is further composed of a healthy type 303, a vegetable lover 304, and a housewife 305, for example. The concept grant result data 114 is configured in matrix format, and indicates the correspondence between each concept concerning the consumer and the consumer ID. A field 306 indicates the correspondence between the consumer identified by “AAAAA0001” and the healthy type 303. In FIG. 3, the field has “0”, meaning that the consumer “AAAAA0001” does not belong to the healthy type 303. A field 307 indicates the correspondence between the consumer identified by “AAAAA0001” and the vegetable lover 304. In FIG. 3, the field has “1”, indicating that the consumer “AAAAA0001” belongs to the vegetable lover 304. The concepts relating to the same corresponding data are displayed on the same matrix. A concept of corresponding data that differ in, e.g., the concept concerning the product is noted on a matrix for the corresponding data.

### (1-2-2) Causal Relationship Hypothesis Input Screen

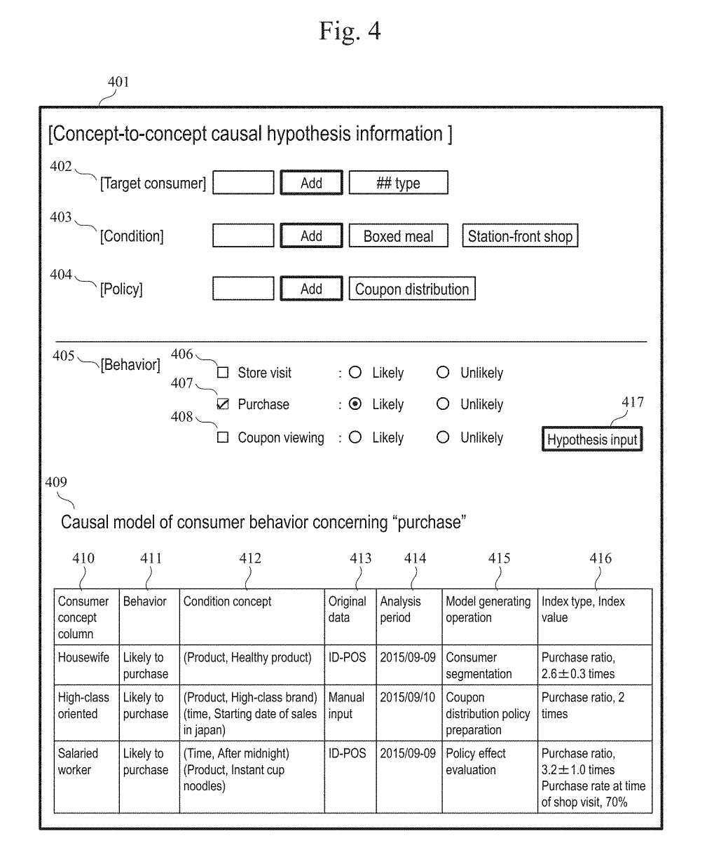

FIG. 4 illustrates an example of a causal relationship hypothesis input screen 401 used for accepting the concept-to-concept causal relationship hypothesis information 104. The concept-to-concept causal relationship hypothesis information 104 refers to information concerning factors affecting the consumption behavior of the consumer and the influence type. In the causal relationship hypothesis input screen 401, an arbitrary concept concerning the consumer and the relationship between arbitrary factors that can affect the consumer group belonging to the concept can be input. The causal relationship may be input by the person in charge of operations via the causal relationship hypothesis input screen 401. Alternatively, a causal relationship estimated from the concept such as “consumer”, “product”, “area”, or “time period” defined in the screen definition screen 201 (FIG. 2) may be input.

In the hypothesis input screen 401 illustrated in FIG. 4, a target consumer 402, a condition 403, an operation 404, and a behavior 405 are arranged as input items for generating a causal hypothesis. The behavior 405 is used for inputting a hypothesis as to whether, due to the influence of a “specific condition such as product/area” or an “operation execution content”, store visit 406, purchase 407, or coupon viewing 408 by the target consumer is promoted or discouraged. When the person in charge of operations clicks a hypothesis input button 417, the input information is noted in the causal relationship table 115.

By also providing the hypothesis of causal relationship with information as to compared with what the actual relationship indicates the tendency of, such as “On a rainy day (compared with no rainy day), female consumers are less likely to visit store”, or “On a rainy day, female consumers (compared with non-female consumers) are less likely to visit store”, more hypotheses can be incorporated into the causal model. For example, a method where “A condition that is not made an object of comparison is added to the prerequisite”, or a method where “Each condition is provided with an alternative as to whether the condition is made an object of comparison”, may be adopted, whereby more causal relationships can be modeled.

In the causal relationship hypothesis input screen 401, a display portion 409 for “Causal model of consumer behavior concerning purchase” is also arranged. In the display portion 409, the causal models related to the purchase by the consumers that have already been estimated. The causal model includes: a consumer concept column 410; a column 411 concerning behavior; a condition concept column 412; an original data column 413; an analysis period column 414; a model generating operation column 415; and an index type/index value column 416. In the column 411, a consumption behavior that is affected by the purchase/store visit and the like is noted. In the column 412, affecting conditional concepts are noted in a pair of corresponding data type and concept name, such as “(product, healthy product)”. In the column 413, information about the original data from which the displayed causal relationship has been recognized is noted. In the column 414, the analysis period is noted. In the column 415, information indicating the operation content at the time of recording of each causal relationship in the system is noted. In the column 416, information about an index type and a value thereof based on which the determination of presence of a causal relationship has been made is noted.

In the case of FIG. 4, the causal model indicating that “housewives are likely to purchase healthy products” means, quantitatively, that “the ratio of purchase rate is 2.6±0.3 times between consumer groups other than the housewives and the consumer group of housewives”. The value may be a value calculated based on input information, or a manually input predicted value. The causal model may be constructed not just according to the purchase ratio (the ratios of purchase rate between consumer groups), but also according to other indexes, such as the purchase rate at the time of store visit (the probability of making a purchase when visiting a store), or a plurality of indexes that may form the grounds with respect to a single model may be recorded for the model.

In FIG. 4, the causal relationship hypotheses are accepted manually. However, a causal relationship may be estimated automatically using data and concept information defined in the past. For example, purchase rates between concepts may be calculated, and, based on a calculated value, it may be estimated that “there is a causal relationship between a consumer concept and a product concept with high purchase rates”. Alternatively, instead of recording the input hypothesis as a causal relationship as is, the causal relationship between an input concept and actual data may be evaluated, and the association between the concept and the actual data or the causal relationship may be updated in order to construct a more accurate causal model.

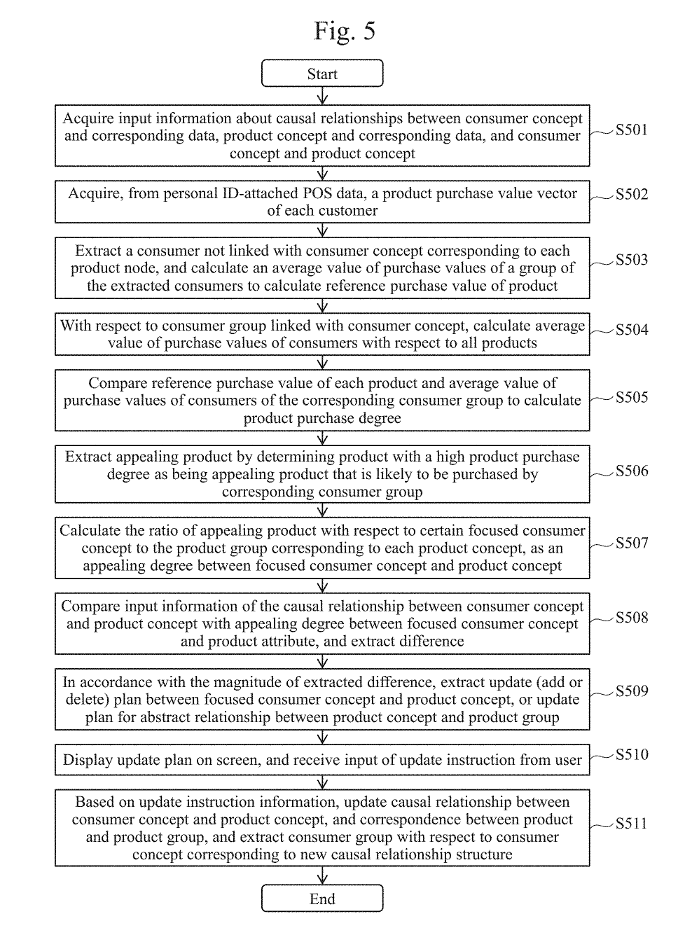

FIG. 5 illustrates a method for updating the association between concepts concerning consumers/products and actual data, and concept-to-concept causal relationships on the basis of values segmentation. Some concepts may be defined as a data group including some causal relationship, such as “a consumer group that likes cosmetics”. In such a case, the process illustrated in FIG. 5 updates (1) a concept-to-concept causal relationship, and (2) a correspondence between concept and data. However, with respect to concepts that are irrelevant to a causal relationship, such as “female”, only the causal relationship may be updated without updating the correspondence between the concept and data, or a new concept that could be a broader concept or a narrower concept of “female” may be proposed.

In step S501, the causal relationship estimation/concept update unit 111 acquires input information about the causal relationships between a consumer concept and corresponding data, a product concept and corresponding data, and the consumer concept and the product concept. In step 502, the causal relationship estimation/concept update unit 111 acquires, from personal ID-attached POS data 132, a product purchase value vector of each customer. As the product purchase value vector of each customer, a vector expressing the presence or absence of purchase experience of the customer with respect to each product by I/O may be contemplated. Vectors concerning the number of times of purchase, the purchase ratio and the like may also be used. In step S503, the causal relationship estimation/concept update unit 111 extracts a consumer not linked with the consumer concept corresponding to each product node, and calculates an average value of the purchase values of a group of the extracted consumers to calculate a reference purchase value of the product. The reference purchase value of the product may be based on other than the result of the above-described calculation. If a general purchase value with respect to a certain product can be obtained from conventional knowledge, that value may be adopted.

In step S504, the causal relationship estimation/concept update unit 111, with respect to a consumer group linked with the consumer concept, calculates an average value of the purchase values of the consumers with respect to all products. In step S505, the causal relationship estimation/concept update unit 111 compares the reference purchase value of each product and the average value of the purchase values of the consumers of the corresponding consumer group to calculate a product purchase degree. For example, the ratio of the average value of the purchase values of the consumers with respect to the reference purchase value may be calculated and used as the product purchase degree. Alternatively, the population of the reference purchase value and the population of the average value of a focused purchase value may be statistically compared to calculate the probability of the populations being not identical. In step S506, the causal relationship estimation/concept update unit 111 extracts an appealing product by determining a product with a high product purchase degree as being the appealing product that is likely to be purchased by the corresponding consumer group. A non-appealing product may be similarly defined by considering a product with a low product purchase degree not likely to be purchased, for example. It is also possible to set three items of “likely to be purchased”, “average”, “not likely to be purchased”, calculate the probability of belonging to each item, and express the relationship between the consumer concept and the product as continuous value vectors.

In step S507, the causal relationship estimation/concept update unit 111 calculates the ratio of the appealing product with respect to a certain focused consumer concept to the product group corresponding to each product concept, as an appealing degree between the focused consumer concept and the product concept. In other words, step S507 is a step of estimating a causal relationship degree based on data between the consumer concept and the product concept when the products are classified according to whether the products are an appealing product (I/O). In step S508, the causal relationship estimation/concept update unit 111 compares the input information of the causal relationship between the consumer concept and the product concept with the appealing degree between the focused consumer concept and a product attribute, and extracts a difference.

In step S509, the causal relationship estimation/concept update unit 111, in accordance with the magnitude of the extracted difference, extracts an update (add or delete) plan between the focused consumer concept and the product concept, or an update plan for the abstract relationship between the product concept and the product group. A uniform threshold value may be provided for the difference. Alternatively, when there are causal relationships between the focused consumer concept and a plurality of product concepts, a threshold value for deciding whether to update or not may be determined based on the difference between data concerning the causal relationship with another product concept and the input information.

In step S510, the causal relationship estimation/concept update unit 111 displays the update plan on the screen, and receives the input of an update instruction from the person in charge of operations. It should be noted, however, that the execution of this step may be skipped and updating may be performed automatically without accepting the input from the person in charge of operations. In step S511, the causal relationship estimation/concept update unit 111, on the basis of update instruction information, updates (1) the causal relationship between the consumer concept and the product concept, and (2) the correspondence between the product and the product group, and extracts a consumer group with respect to the consumer concept corresponding to a new causal relationship structure. That is, by the process illustrated in FIG. 5, it is possible to estimate (1) a causal relationship reflecting data appropriately, and (2) the association between the concept and data. While in FIG. 5 only the updating of addition or deletion of a path of causal relationship is proposed, it is also possible, by performing clustering analysis or network analysis and the like in the focused consumer group, to perform concept integration or division, such as “divide the consumer group” or “integrate different consumer groups having the same causal relationship”, and to perform causal relationship update accordingly.

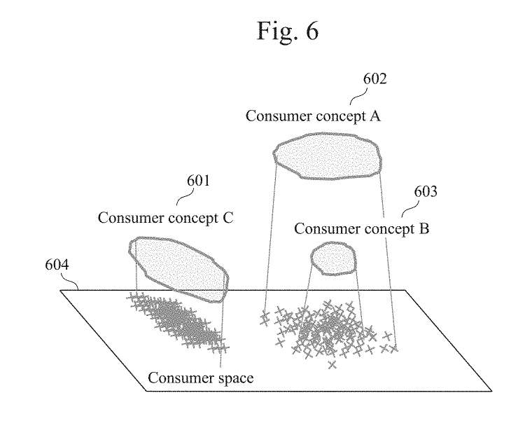

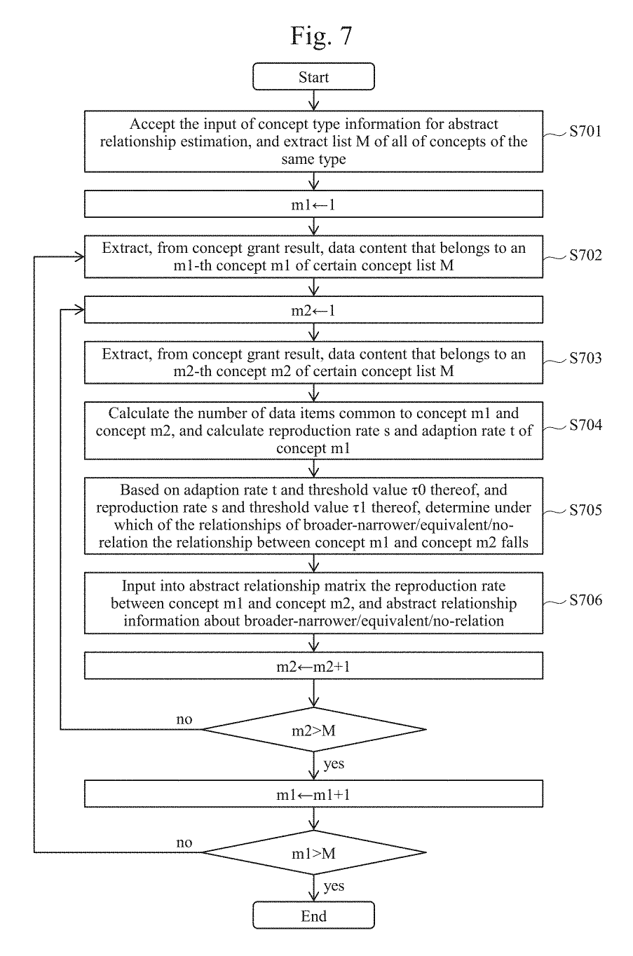

In the present Example, based on a coordination of the analysis technology illustrated in FIG. 5 and a modeling technology concerning a concept-to-concept abstract relationship which will be described with reference to FIG. 6 and FIG. 7, construction of an integrated model or post-operation implementation model evaluation utilizing the constructed integrated model is performed. As illustrated in FIG. 4, there is a plurality of causal models between the factors affecting consumer behavior and the consumer concept. The behavior of each consumer is subject to the influence of the plurality of causal models simultaneously. Accordingly, when the effect at the time of actual operation implementation is predicted, it is necessary to coordinate the plurality of causal models, and perform comprehensive influence prediction. In addition, the coordination of a plurality of causal models requires estimation of the abstract relationship between the concepts constituting the causal models. In the present Example, the concept-to-concept abstract relationship is estimated based on the degree of overlap of the data sets constituting the respective concepts, and the coordination between the causal models on actual data is achieved.

FIG. 6 illustrates a pictorial representation of the abstract relationship between a plurality of concepts over a consumer space 604. Because the abstract relationship of concepts is estimated based on the degree of overlap of data sets, the abstract relationship is a relationship that exists only between concepts of the same data type. In the illustrated example, some of the consumers belonging to “consumer concept A” 602 belong to “consumer concept B” 603, while all of the consumers belonging to the “consumer concept B” belong to the “consumer concept A”. None of the consumers belonging to the “consumer concept C” 601 belong to the “consumer concept A” and the “consumer concept B”.

In this case, because the set of the “consumer concept A” includes the “consumer concept B”, the “consumer concept A” is contemplated to be a broader concept in relation to the “consumer concept B”. The “consumer concept B” is a narrower concept in relation to the “consumer concept A”, and the “consumer concept C” is in no-relationship with both the “consumer concept A” and the “consumer concept B”. The abstract relationship of two concepts falls within “broader-narrower”, “equivalent”, or “no-relation”.

FIG. 7 illustrates an abstract relationship estimation process procedure. FIG. 7 illustrates the procedure where concept type information as the object of estimation (for example, a concept concerning the consumer) is accepted in advance, and the abstract relationship between concepts concerning the type is estimated. In step S701, the abstract relationship estimation unit 112 accepts the input of the concept type information for abstract relationship estimation, and extracts a list M of all of concepts of the same type. In the next step and thereafter, the abstract relationship estimation unit 112, with respect to each concept in the concept list M, estimates and records the abstract relationship with the other concepts in the concept list M.

In step S702, the abstract relationship estimation unit 112, with respect to each concept of the certain concept list M, extracts from the concept grant result data 114 data that belong to an m1-th concept m1. In step S703, the abstract relationship estimation unit 112 extracts from the concept grant result data 114 data that belong to an m2-th concept m2 from the certain concept list M. In step 704, the abstract relationship estimation unit 112 calculates the number of data items common to the concept m1 and the concept m2 (the number of common data items), and, based on the number, calculates a reproduction rate s and an adaption rate t of the concept m1. The reproduction rate s and the adaption rate t are examples of a value indicating the ratio of a certain concept being “linked with” another concept. The adaption rate t is the ratio of the number of common data items to the number of data items of one concept (for example, the concept m1). The reproduction rate s is the ratio of the number of common data items to the number of data items of the other concept (for example, the concept m2).

In step S705, the abstract relationship estimation unit 112, based on the adaption rate t and a threshold value TO thereof, and the reproduction rate s and a threshold value τ1 thereof, determines under which of the relationships of broader-narrower/equivalent/no-relation the relationship between the concept m1 and the concept m2 falls. The threshold value TO and the threshold value τ1 may be arbitrarily determined. For example, if the adaption rate t and the reproduction rate s both exceed the threshold values, the relationship is determined to be “equivalent”; if only the adaption rate t exceeds the threshold value, it is determined that the concept m1 is “broader”; if only the reproduction rate s exceeds the threshold value, it is determined that the concept m1 is “narrower”. In step S706, the abstract relationship estimation unit 112 inputs into the abstract relationship matrix the reproduction rate s between the concept m1 and the concept m2, and the abstract relationship information about broader-narrower/equivalent/no-relation.

In the process procedure illustrated in FIG. 7, the concept-to-concept abstract relationship is estimated on a round-robin basis. This technique, however, may lead to an increase in the amount of computation if the number of concepts is large. On the other hand, by using the following rules, the abstract relationship can be estimated without using a round-robin, whereby the computation time can be reduced. The rules include, for example: a rule where if the concept m2 is a narrower concept of the concept m1, a narrower concept of the concept m2 is considered a narrower concept of the concept m1; and a rule where if the concept m2 is a broader concept of the concept m1, a broader concept of the concept m2 is considered a broader concept of the concept m1.

### (1-2-3) Parameter Design Screen and Analysis Screen

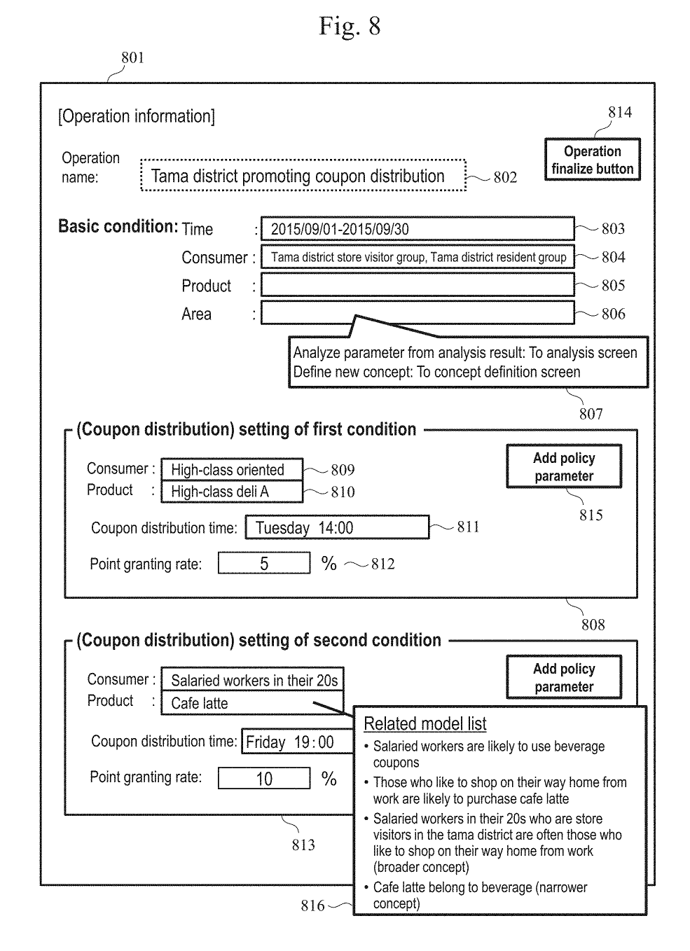

FIG. 8 illustrates an example of an operation parameter design screen 801. The operation parameter design screen 801 is used when specific parameters of a service operation planned to be provided are input. In an operation name 802, the name indicating the content of the operation being planned is input. In FIG. 8, a “Tama district promoting coupon distribution” service is input. Under the operation name 802, entry fields for related basic conditions are arranged. In a time 803, the operation period is input. In a consumer 804, an operation target consumer is input. In a product 805, an operation target product is input. In an area 806, an area is input. These conditions may not be able to be designated depending on the operation content. For example, in the case of a storefront sales, the target consumers are the store visitors at the time of operation implementation, and therefore cannot be set in advance.

The operation parameter design screen 801 is also provided with a detailed condition entry field. In FIG. 8, a first entry field 808 and a second entry field 813 are provided. In the first entry field 808, information such as a coupon distribution target consumer 809, a product 810, a coupon distribution time 811, and a point granting rate 812 is input. In the second entry field 813, similar information is input. In the case of FIG. 8, in the first entry field 808 and the second entry field 813, the conditions with respect to different target persons and products are input.

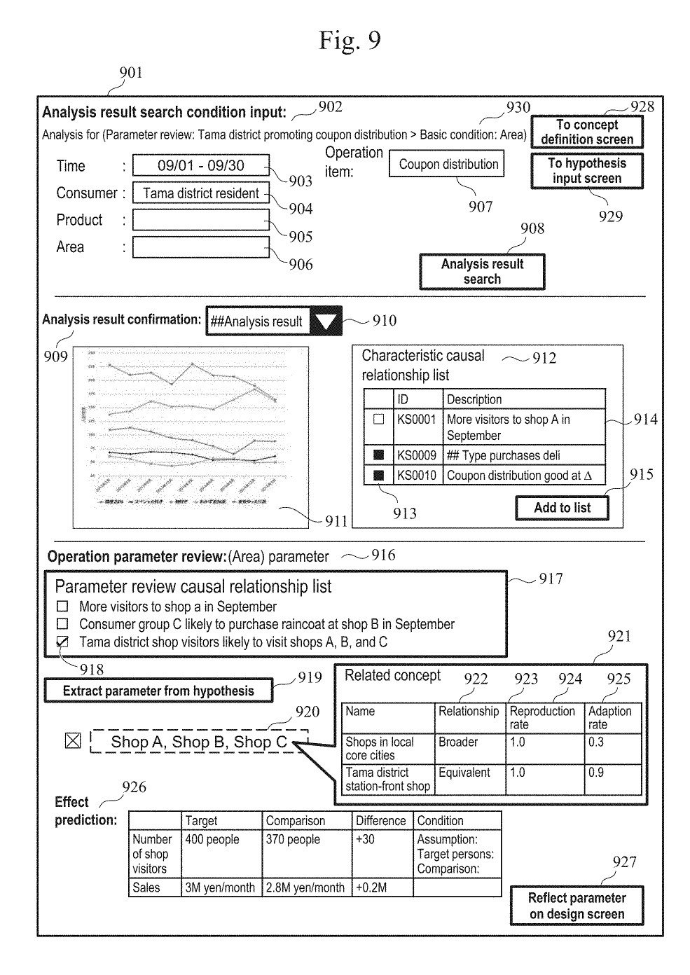

An operation finalize button 814 is a button for recording the operation information after the input of the operation parameters. In a select box 807 corresponding to the area 806, the parameter input method can be selected. If “analyze parameter from analysis result” is selected, an analysis screen 901 (FIG. 9) opens. In this case, a parameter that seems to be highly effective can be selected on the basis of the analysis result. On the other hand, if “define new concept” is selected, a concept definition screen 201 opens. In this case, a new concept concerning area can be input. The analysis screen 901 will be described later.

An “add operation parameter” button 815 is a button for modifying the parameters per se that are to be controlled by the operation. For example, it is possible to add a condition such as the presence or absence of a coupon design or photograph display to the coupon distribution condition. For example, when an additional service for distributing a message application stamp is implemented in order to distribute coupons for youth, any improvement made in the distributed coupon design may be incorporated by adding a parameter as a variable item in the operation, whereby it becomes possible to construct a consumer behavior model in which the influence of the new parameter is also taken into consideration. In the case of a new parameter for which no past operation implementation history exists, data may be lacking. Accordingly, a certain period for data integration may become necessary in order to perform quantitative influence evaluation. Even for a period in which no quantitative values can be calculated, it is believed that a qualitative analysis by the person in charge of operations can be assisted by displaying on the operation evaluation screen a parameter that can explain an error factor between a prediction and an actual measurement.

A related model list 816 indicates a set of the factor-to-factor causal relationship models and the abstract relationship models used as presupposed knowledge when the content of a parameter is determined. In the example of FIG. 8, as a list of the causal relationships and the abstract relationships that have been used when determining the operation content of distributing a “cafe latte” coupon to salaried workers in their 20s, there are displayed the causal relationship models concerning purchase/coupon use, such as “Salaried workers are likely to use beverage coupons” and “Those who like to shop on their way home from work are likely to purchase cafe latte”, and the abstract relationship models, such as “Salaried workers in their 20s who are store visitors in the Tama district are often those who like to shop on their way home from work”.

### (1-2-4) Analysis Screen

FIG. 9 illustrates an example of an analysis screen 901 used for, e.g., extraction and confirmation of a model group (causal relationship model, abstract relationship model) concerning a plurality of concepts linked with the content of a certain parameter, and extraction of the utilized models. The analysis screen 901 is a screen for deeply understanding the consumption behavior model of customers by enabling the confirmation of an analysis result focusing on various data sources, and for appropriately analyzing the operation parameters.

In the analysis screen 901, a search condition input portion 902 which is used for narrowing the analysis result to be confirmed is arranged. In the search condition input portion 902, concepts corresponding to, e.g., a time 903, a consumer 904, a product 905, an area 906, and an operation item 907 can be input. By inputting these concepts, it becomes possible to narrow only the analysis data in accordance with the data that belong to the input concepts. The analysis screen 901 is displayed by, for example, transition from the operation parameter design screen 801 illustrated in FIG. 8, and is used for analysis result confirmation or parameter review. In a display portion 930, the content of the current operation phase (the parameters being specifically analyzed) is noted. In the example of FIG. 9, “Analysis for (Parameter review: Tama district promoting coupon distribution >Basic condition: area)” is being displayed, indicating that a review work for operation area is underway.

In the analysis screen 901, a display portion 909 used for analysis result confirmation is arranged. In a list box 910 of the display portion 909, an analysis result list narrowed by the pressing of an analysis result search button 908 is set. When an analysis result is selected in the list box 910, a corresponding analysis result 911 and a list of characteristic causal relationships (characteristic causal relationship list) 912 derived from the analysis result are displayed. A table 914 is a causal relationship list, where each causal relationship is provided with a check box 913. Because the analysis screen 901 is an analysis screen for an area parameter analysis, only the causal relationship that refers to a concept concerning area in the table 914 is displayed in a state in which the check box 913 can be checked. In the case of FIG. 9, the check box 913 that can be checked is indicated by solid white, while the check boxes 913 that cannot be checked are indicated by solid black.

When an add to list button 915 is clicked, the causal relationship with the check box 913 checked is added to the list. In the example of FIG. 9, because the causal relationship in the first row of the table 914 (hypothesis ID “KS0001”) is the causal relationship concerning the area of shop A, the check box 913 is in a checkable state. On the other hand, the causal relationships in the second and the third rows of the table 914 are both causal relationships concerning factors having no relationship with area, and therefore their check boxes 913 are inactive. In the table 914, only the causal relationship related to area may be displayed.

The add to list button 915 is a button for causing a causal relationship that the person in charge of operations wishes to focus on during analysis result confirmation to be displayed on an operation parameter review display portion side. In this way, the person in charge of operations can review an effective operation parameter while comparing a plurality of causal relationships, extracted from a plurality of analysis results, on the same screen.

The analysis screen 901 is provided with an operation parameter review portion 916. The operation parameter review portion 916 includes: a causal relationship list display portion 917 in which a list of causal relationships that appear likely to be utilizable for parameter review is displayed; a parameter candidate display portion 920; and a display portion 926 for effect prediction results in the case of setting candidate parameters. The display content of the parameter candidate display portion 920 may be input either manually or automatically. Automatic input is made according to the following procedure, for example. First, the person in charge of operations checks and selects the check box 918 for a causal relationship that appears likely to provide grounds for parameter determination among the plurality of causal relationships being displayed in the causal relationship list display portion 917, and presses an “Extract parameter from hypothesis” button (extract button) 919. Then, the operation effect prediction model construction unit 118 extracts concepts concerning area from the selected causal relationship, and causes them to be displayed in the display portion 920 as parameter candidates.

The parameter candidate display portion 920 is attached with a display portion 921 for displaying concepts having an abstract relationship with the extracted concepts. The display portion 921 includes a table with the display items of a concept name 922, a relationship 923 with a parameter candidate concept to be focused, a reproduction rate 924, and an adaption rate 925. Through confirmation of the relationship 923, information about concepts having an abstract relationship with the extracted concepts can be obtained, whereby a difficult perspective with respect to a certain data set can be identified. Based on the displayed information, the person in charge of operations can, for example, set a relating concept as a parameter, or confirm the analysis result concerning a related concept. In this way, the person in charge of operations can identify the tendency of consumer behavior from various perspectives, and review the operation.

The analysis screen 901 is also provided with a “To concept definition screen” transition button 928 and a “To hypothesis input screen” transition button 929. For example, when it is desired to define a new concept during analysis result confirmation or operation parameter review, by operating the “To concept definition screen” button 928, transition to the screen definition screen can be made. Meanwhile, when manual hypothesis input is necessary, by operating the “To hypothesis input screen” button 929, transition can be made to the concept definition screen causal relationship hypothesis input screen 401 or the abstract relationship hypothesis generation screen. When a “Reflect parameter on design screen” button 927 is clicked, the information on the screen is reflected on the design screen.

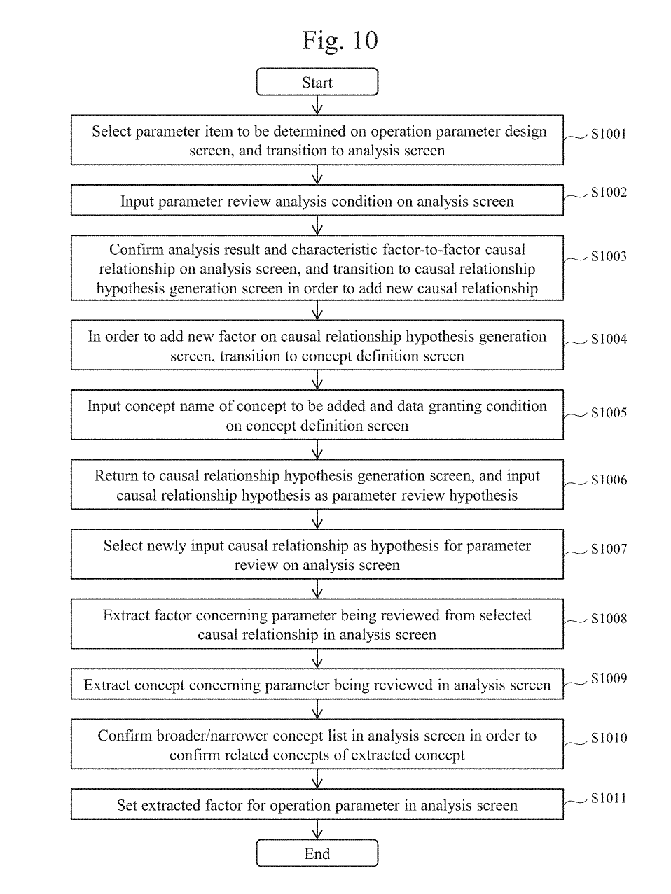

FIG. 10 illustrates a work procedure for the person in charge of operations when designing an operation parameter. First, the person in charge of operations selects a parameter item to be determined on the operation parameter design screen 801, and causes the manipulation screen display to transition to the analysis screen 901 (step S1001). Then, the person in charge of operations inputs a parameter review analysis condition on the analysis screen 901 (step 1002). The input is made through the search condition input portion 902.

The person in charge of operations confirms the analysis result 911 and the characteristic causal relationship list 912 displayed in the display portion 909 of the analysis screen 901, and clicks the “To hypothesis input screen” button 929 in order to add a new causal relationship, thereby causing transition to the causal relationship hypothesis input screen 401 (step S1003). The person in charge of operations, in order to add a new factor, clicks an add button in the causal relationship hypothesis input screen 401 to cause transition to the concept definition screen 201 (step S1004). In the concept definition screen 201, the person in charge of operations inputs the concept name of the concept to be added, or a data granting condition (step S1005). The person in charge of operations clicks the enter button 207 in the concept definition screen 201 to return to the causal relationship hypothesis generation screen 401.

Then, the person in charge of operations clicks the hypothesis input button 417 to input a hypothesis of the causal relationship between the added concept and a consumer group (step S1006). By the clicking of the hypothesis input button 417, the working screen returns to the analysis screen 901. Further, the person in charge of operations in the analysis screen 901 selects the newly input causal relationship as a hypothesis for parameter review (step S1007). The selection is made by checking the check box 918. Thereafter, the person in charge of operations clicks the “Extract parameter from hypothesis” button 919, thus instructing the extraction of a factor concerning the parameter being reviewed from the selected causal relationship (step S1008). The person in charge of operations also in the analysis screen 901 extracts a concept concerning the parameter being reviewed (step S1009). This confirmation is made through the display portion 921.

The person in charge of operations then, in order to confirm a related concept of the extracted concept, confirms a broader/narrower concept list in the analysis screen 901 (step S1010). Specifically, the relationship 923 in the display portion 921 is viewed. The person in charge of operations further sets the extracted factor for an operation parameter in the analysis screen 901 (step S1011). Specifically, the “reflect parameter on design screen” button 927 is clicked.

The above-described procedure is an example, and the working screen transitions are also examples. In practice, the display of working screens in the present Example may not necessarily be sequentially executed, and various screen transition patterns may be possible, such as starting from the analysis screen 901, or transitioning from the operation parameter design screen 801 to the concept definition screen 201.

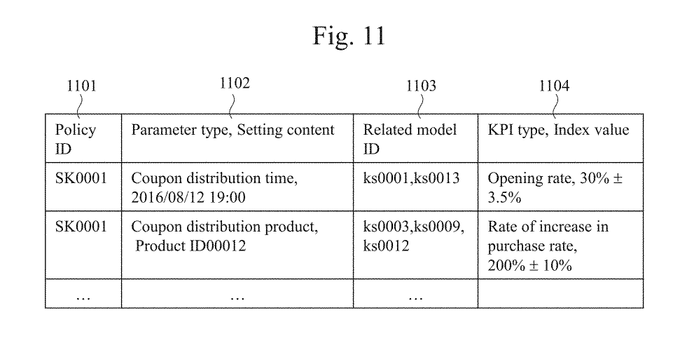

FIG. 11 illustrates an example of the operation ID×model ID table 119 that is the operation parameter design result. In the present Example, not only a plurality of operation parameter information items that determine operation content and target key performance indicators (KPI), but also the model ID of a causal relationship/abstract relationship concerning a consumer behavior that has been focused on the analysis screen 901 when reviewing the above values is recorded in a linked manner. Accordingly, the operation ID×model ID table 119 is composed of an “operation ID” 1101, a “parameter type, setting content” 1102, a “related model ID” 1103, and a “KPI type, index value” 1104. By recording such information for each operation, it becomes possible to evaluate, during an evaluation after operation implementation, not only the operation content but also the consumer behavior tendency model that has been used when the operation was derived. In this way, the person in charge of operations can identify, through operation implementation and evaluation, a more realistic consumer behavior tendency, making it possible to run the PDCA continuously. For the KPI values, target values may be manually set, or the effect prediction values displayed in the effect prediction results display portion 926 may be automatically selected as the target values.

### (1-2-5) Operation Evaluation Screen

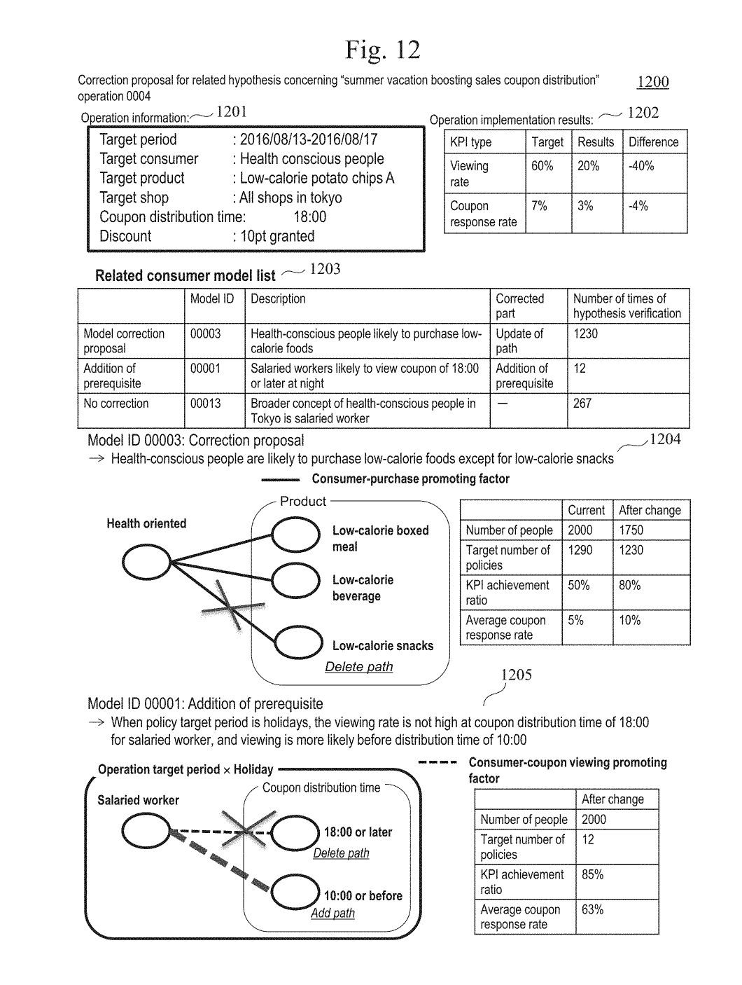

FIG. 12 illustrates an example of an operation evaluation screen 1201. The screen is created and displayed by the model evaluation/update unit 120. In an “operation information” display portion 1201, operation parameter content information is displayed. In an “operation implementation result” display portion 1202, information concerning a operation KPI target and the results of actual implementation are displayed. The information enables the person in charge of operations to confirm the operation effect. In a “Related consumer model list” display portion 1203, a list of models of the causal relationship/abstract relationship linked with the corresponding operation is displayed.

In the present Example, not only the “operation implementation result” but also the consumer purchase tendency of each model are evaluated, and the consumer behavior tendency is corrected at model level, whereby a more realistic understanding of consumer behavior is promoted. In this way, creation of an operation improvement plan is assisted.

With regard to the evaluation of a related consumer model, if there is a discrepancy between the assumed consumer model and the purchase pattern according to the actual operation history, the cause may lie in (1) a discrepancy of the tendency of the model itself from the current situation, or (2) a tendency different from the assumption is indicated by the specific cause and effect of the current operation.

With respect to (1), the tendency of the model itself can be evaluated based on an operation implementation history derived from the focused consumer model including the current operation, or related purchase behavior data. A “model ID0003: correction proposal” 1204 is an example of proposal to evaluate the model itself and to reach a more realistic structure. While in the present case, deletion of a causal relationship path is proposed, a path addition proposal may be made. In addition, for example, a concept dividing proposal may be made to divide the one health-oriented consumer group into two consumer concepts of those seeking beauty and those seeking prevention of diseases. Conversely, when the two concepts of health consciousness and joggers have in fact a causal relationship with the same product group, a proposal may be made to integrate the two. Such evaluation and update proposals may be achieved using the technology described with reference to FIG. 5.

With respect to (2), in an entire data evaluation, the tendency of the focused operation and the model tendency may not agree with each other even if no difference is recognized between the model tendency and the reality. This may be due to the presence of a specific factor in the current operation data that does not exist in other cases. Accordingly, a “concept” linked with data that does not agree with the model tendency including the target operation data and a “concept” linked with data agreeing with the model tendency are compared to extract the specific factor in the current operation data, in an attempt to identify the cause of the disagreement of the model tendency.

A “model ID0001: addition of prerequisite” 1205 indicates that, in the operation with the operation target period of “holiday”, the causal relationship of the coupon distribution time with respect to salaried workers is different from the assumed model. In the present Example, by searching for a parameter factor that achieves the KPI under the condition in which the further extracted factor may be present, a proposal for a new causal model is made. In the example of FIG. 12, when the operation target period is “holiday”, the viewing rate achieves 60% or more of the target when the coupon distribution time is earlier than 10:00.

In this way, by previously defining and recording a concept linked with data, it becomes possible to express a new causal relationship derived from the operation implementation history using the previously defined concept, and to make a tendency presentation that is easy for the person in charge of operations to understand.

### (1-3) Effects of the Example

As described above, by using the assistance system according to the present Example, it becomes possible to construct a model group of the causal relationship/abstract relationship of the consumer in which the qualitative knowledge and concept of the person in charge of operations are linked with operation history data, and to achieve operation implementation result evaluation from the perspective of operation parameter design in which analyses from a plurality of data items and perspectives are integrated, or from consumer behavior tendency. In addition, according to the assistance system of the present Example, it becomes possible, using a plurality of items of operation history data about the individual purchase history and the like as inputs, with respect to an arbitrary concept concerning the data items of an operation history, to estimate the correspondence between the concept and the data belonging to the concept, the causal relationship between a plurality of concepts concerning different data items, and the upper-lower/identical/no-relation between a plurality of concepts concerning the same data item. As a result, the person in charge of operations, based on various qualitative operation knowledge including his or her own qualitative experience and intuition, can generate a causal relationship model that has a high degree of freedom with respect to the operation implementation results and their factors, and which is precise with respect to the actual data tendency, and review an effective operational plan efficiently based on the generated causal relationship.

### (2) Other Examples

The present invention is not limited to the above-described Example and may include various modifications. The Example has been described in detail for facilitating an understanding of the present invention, and may not necessarily require all of the elements described. A part of one example may be replaced with the configuration of another example. The configuration of the other example may be incorporated into the configuration of the one example. With respect to a part of the configuration of an example, addition, deletion, or substitution of a part of the configuration of another example may be possible.

The technology described above may be used for operation planning assistance or operation implementation result evaluation by persons in charge of operations engaged in various operations other than retail operations. Because the operation-related causal/abstract relationships used as a prerequisite during operation preparation by a certain person in charge of operations are recorded, the technology may be may be used for consensus building among a plurality of persons in charge of operations. By reviewing the history of the linked results of the operation and the causal/abstract relationship model on a person in charge of operations basis, it becomes possible to perform not only operation evaluation but also evaluation of the person in charge of operations who plan the operation. The technology may also be applied to an operational training system and the like for persons in charge of operations.

The configurations, functions, processing units, processing means and the like described above may be partly or entirely provided by hardware by, for example, designing them on integrated circuitry. The configurations, functions and the like may be provided by a processor interpreting and executing a program for achieving the respective functions (i.e., using software). Information about the programs, tables, files and the like for achieving the functions may be stored in a storage device such as a memory, hard disk, or a solid state drive (SSD), or in a storage medium such as an IC card, an SD card, or a DVD. The control lines and information lines shown in the drawings are those considered necessary for description purposes, and may not indicate all of the control lines or information lines required in a product. In practice, almost all of the elements are mutually connected.

### REFERENCE SIGNS LIST

1 Assistance system (operation planning and its effect verification assistance system)
100 Terminal
101 Central server
102 Concept design initial information
103 Concept integration/division and causal relationship update plan
104 Concept-to-concept causal relationship hypothesis information
105 Concept-to-concept abstract relationship hypothesis information
106 Analysis condition
107 Operation information
108 Concept-to-concept causal/abstract relationship characteristics (hypothesis) list
109 Model generator
110 Concept definition unit
111 Causal relationship estimation/concept update unit
112 Abstract relationship estimation unit
113 Causal/abstract relationship data model information
114 Concept grant result data
115 Causal relationship table
116 Abstract relationship matrix
117 Operation item information table
118 Operation effect prediction model construction unit
119 Operation ID×model ID table
120 Model evaluation/update unit
121 Concept definition screen display unit
122 Causal relationship hypothesis generation screen display unit
123 Abstract relationship hypothesis generation screen display unit
124 Analysis screen display unit
125 Operation parameter design screen display unit
126 Operation evaluation screen display unit
131 Operation data storage
132 ID-POS
133 Customer information
134 Product master
135 Operation implementation history

1. A verification assistance system comprising:
a first computation unit which searches a database by a name of a concept defined by an arbitrary word, and which extracts a plurality of behavior history data linked with the concept;
a second computation unit which, by calculating the number of data items that are common among the plurality of extracted behavior history data, a ratio by which a certain concept is linked with another concept; and
a third computation unit which, based on the ratio, determines whether the certain concept and the other concept have an abstract relationship of any of upper/lower, identical, and no-relation.

2. The verification assistance system according to claim 1, comprising:
a fourth computation unit which estimates a causal relationship between a certain concept and a factor that promotes or discourages a specific behavior by a target person; and
a fifth computation unit which, using the abstract relationship, integrates a plurality of the causal relationships with respect to a certain event.

3. The verification assistance system according to claim 2, wherein the fifth computation unit displays a model of the causal relationship and the abstract relationship relating to a concept that is input.

4. The verification assistance system according to claim 2, wherein the fifth computation unit, based on an operation implementation history read from the database, creates and displays an update proposal for the causal relationship and/or the abstract relationship.

5. The verification assistance system according to claim 4, wherein the update proposal includes deletion, addition, division, or integration of a path between a certain concept and a certain factor.

6. The verification assistance system according to claim 1, wherein the third computation unit displays the abstract relationship between the certain concept and the other concept.

7. The verification assistance system according to claim 1, wherein the third computation unit displays the ratio calculated between the certain concept and the other concept.

8. The verification assistance system according to claim 1, wherein the linked with ratio includes an adaption rate which is the ratio of the number of common data items in the number of data items of the certain concept, or a reproduction rate which is the ratio of the number of common data items in the number of data items of the other concept.

9. A verification assistance method executed in a server, the method comprising:
a first process of searching a database by a name of a concept defined by an arbitrary word to extract a plurality of behavior history data linked with the concept;
a second process of calculating the number of data items that are common among the plurality of extracted behavior history data to calculate a ratio by which a certain concept is linked with another concept; and
a third process of determining, based on the ratio, whether the certain concept and the other concept have an abstract relationship of any of upper/lower, identical, and no-relation.

10. The verification assistance method according to claim 9, further comprising:
a fourth process of estimating a causal relationship between a certain concept and a factor that promotes or discourages a specific behavior by a target person; and
a fifth process of, using the abstract relationship, integrating a plurality of the causal relationships concerning a certain event.

11. The verification assistance method according to claim 10, further comprising a sixth process of displaying a model of the causal relationship and the abstract relationship relating to a concept that is input.

12. The verification assistance method according to claim 10, comprising a sixth process of creating and displaying, based on an operation implementation history read from the database, an update proposal for the causal relationship and/or the abstract relationship.

13. The verification assistance method according to claim 12, wherein the update proposal includes deletion, addition, division, or integration of a path between a certain concept and a certain factor.

14. The verification assistance method according to claim 9, further comprising a fourth process of displaying the abstract relationship between the certain concept and the other concept.

15. The verification assistance method according to claim 9, further comprising a fourth process of displaying the ratio calculated between the certain concept and the other concept.
